(19) United States
(12) Patent Application Publication
(10) Pub. No.: US 2005/0050159 A1
(43) Pub. Date: Mar. 3, 2005

(54) Remote debugging of web applications

(76) Inventor: Zeev Suraski, Givatayim (IL)

Correspondence Address: Abelman, Frayne & Schwab, 150 East 42nd Street, New York, NY, 10017, US

(21) Appl. No.: 10/655,088

(22) Filed: Sep. 3, 2003

(51) Int. Cl. G06F 15/16

(52) U.S. Cl. 709/217

(57) ABSTRACT

In a networked environment, debugging of a Web application executing on a Web server is automatically enabled using a single command button on a browser of a remote user. Initiation of debugging and control of the debugging process are achieved using a novel adaptation of the well-known cookie mechanism for storing client information and passing the information from the client to a server. In response to a click event, the client machine generates one or more cookies that contain information regarding the process to be debugged, the client machine itself, and optionally include additional control information. The cookies are transmitted to the server. A server-side process monitors data transmitted from the client. Responsively to recognition of the cookie, the debugging process attaches to the application being debugged and presents itself to the client.

### REFERENCE TO COMPUTER PROGRAM LISTING APPENDIX

Computer program listing appendices are submitted herewith on one compact disc and one duplicate compact disc. The total number of compact discs including duplicates is two. The files on the compact disc are ASCII text files representing source code, a binary Object file, and accompanying files for carrying out the preferred embodiment of the invention. In these files the characters and software object code are displayed as their corresponding values in hexadecimal format.

Their names, dates of creation, directory locations, and sizes in bytes are:

Source code.

CONTENTS.HEX of Aug. 31, 2003 located in the root folder and of length 2,950 bytes;
DIFFS.HEX of Aug. 31, 2003 located in the root folder and of length 47,023 bytes;
ZENDSTUDIOTOOLBARFRAMESJS.HEX of Aug. 31, 2003 located in the root folder and of length 3,599 bytes;
ZENDSTUDIOTOOLBARFRAMESXUL.HEX of Aug. 31, 2003 located in the root folder and of length 3,304 bytes'
ZENDSTUDIOTOOLBAROVERLAYJS.HEX of Aug. 31, 2003 located in the root folder and of length 56,935 bytes;
ZENDSTUDIOTOOLBAROVERLAYXUL.HEX of Aug. 31, 2003 located in the root folder and of length 23,364 bytes;
ZENDSTUDIOTOOLBARSETTINGSJS.HEX of Aug. 31, 2003 located in the root folder and of length 3,717 bytes;
ZENDSTUDIOTOOLBARSETTINGSXUL.HEX of Aug. 31, 2003 located in the root folder and of length 3,127 bytes; and
ZENDSTUDIOTOOLBARABOUTXUL.HEX of Aug. 31, 2003 located in the root folder and of length 2,006 bytes.
   Graphical Objects.
ZENDTOOLBARJPGZIP.HEX of Aug. 31, 2003 located in the root folder and of length 17,877 bytes.
   Object Code.
ZENDTOOLBARXPI.HEX of Aug. 31, 2003 located in the root folder and of length 50,563 bytes.
   Installation.

Detailed installation and execution instructions are found in Appendix 1.

### BACKGROUND OF THE INVENTION

1. Field of the Invention

This invention relates to debugging of computer applications. More particularly, this invention relates to remote debugging of Web applications in a client-server environment.

2. Description of the Related Art

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Development environments for computer applications typically include debugging tools, which enable the developer to identify logical coding errors and runtime errors. Debugging applications in networked client-server environments is considerably more difficult than in a traditional single user computer. In particular, many Web applications are notoriously hard to debug, as they may involve concurrent processes running both on a server and on a client of the server. In such cases, it is difficult to recreate the natural environment of the application being debugged.

Remote debuggers are known. For example, the Java® Development Kit. (JDK) and the Java 2 platform, both available from Sun Microsystems Inc., Palo Alto, Calif., support distributed debugging. In these environments, a standard debugging architecture, the Java Platform Debugger Architecture (JPDA), provides interfaces for debugging tools. Remote debuggers, such as JBuilder®, available from Borland Software Company, Scotts Valley, Calif., employ the JPDA. Such debuggers are even capable of concurrently debugging multiple processes. However, optimum remote debuggers for Web applications usable in a client-server environment still do not exist.

### SUMMARY OF THE INVENTION

According to a disclosed embodiment of the invention, in a networked environment, debugging of a Web application executing on a Web server is automatically enabled using a single command button on a browser of a remote user. Initiation of debugging and control of the debugging process are achieved using a novel adaptation of the well-known cookie mechanism for storing client information, and passing the information from the client to a server. In response to a click event, the client machine generates one or more cookies that contain information regarding the process to be debugged, the client machine itself, and optionally include additional control information. The cookies are transmitted to the server. A server-side process monitors data transmitted from the client. Responsively to recognition of the cookie, the debugging process attaches to the application being debugged and presents itself to the client.

In different modes of operation, it is possible to debug a subsequent page of the Web application, all forms, or even all pages generated by the application.

The invention provides a method for remotely debugging a web application that is executing on a server from a client that is linked to the server in a data network, which is carried out at the client by browsing a page that is generated by the application, generating a cookie at the client responsively to a request by a user to debug the application, and transmitting the cookie to the server via the data network. The server is adapted to actuate a debugger responsively to receiving the cookie, and to connect the debugger to the client so as to enable the page to be debugged at the client.

In one aspect of the method, the cookie is generated by engaging a command button on a browser of the client to cause the cookie to be automatically generated.

In another aspect of the method, a HTTP request is generated in the client for a forced refresh of the page and transmitted to the server.

A further aspect of the method includes memorizing the cookie in the client, and following transmittal of the cookie to the server, causing the client to delete the memorized cookie.

Yet another aspect of the method includes memorizing the cookie in the client, and following transmittal of the cookie to the server, causing the client to preserve the memorized cookie.

In yet another aspect of the method, an instruction is incorporated in the cookie that causes the server to actuate the debugger only after receipt of a HTTP POST request from the client.

According to an additional aspect of the method, the application is written in a scripting language.

The invention provides a method for remotely debugging a web application that is executing on a server from a client that is linked to the server in a data network, which is carried out by receiving a cookie at the server from the client over the data network, and, responsively to the cookie, downloading a page generated by the application on the server to the client, actuating a debugger, and connecting the debugger to the client so as to enable the page to be debugged at the client.

In a further aspect of the method includes the page to be downloaded is a subsequent page of the application.

According to another aspect of the method, the cookie is generated by engaging a command button on a browser of the client to cause the cookie to be automatically generated.

One aspect of the method includes receiving a HTTP request in the server from the client for a forced refresh of the page.

An additional aspect of the method includes transmitting an instruction from the server to the client that causes the client to delete the cookie from a memory thereof.

Still another aspect of the method includes causing the server to withhold sending a delete-cookie instruction to the client.

According to still another aspect of the method, the cookie includes an instruction that causes the server to actuate the debugger only after receipt of a HTTP POST request from the client.

According to one aspect of the method, the application is written in a scripting language.

The invention provides a computer software product, including a computer-readable medium in which computer program instructions are stored, which instructions, when read by a computer, cause the computer to perform a method for debugging a computer application that is executing on a remote server that is linked to the computer in a data network, which is carried out by displaying a page that is generated by the application on a browser in the computer, generating a cookie and transmitting the cookie to the server via the data network, wherein the server is adapted to actuate a debugger responsively to the cookie, and to connect the debugger to the computer so as to enable the page to be debugged.

The invention provides a computer software product, including a computer-readable medium in which computer program instructions are stored, which instructions, when read by a server, cause the server to perform a method for remotely debugging a computer application that is executing on the server from a client that is linked to the server in a data network, which is carried out by receiving a cookie from the client over the data network, and responsively to the cookie, downloading a page generated by the application to the client, actuating a debugger, and connecting the debugger to the client so as to enable the page to be debugged at the client.

The invention provides a computer system for remotely debugging a computer application that is executing on a server that is linked to the system in a data network, including a computer, a memory, a browser executing in the computer, and a toolbar in the browser that has a command button. The toolbar includes program instructions for automatically generating a cookie responsively to engagement of the command button, storing the cookie in the memory, and causing the cookie to be transmitted from the computer to the server via the data network. The server is adapted to actuate a debugger responsively to the cookie, and to connect the debugger to the computer, so as to enable the application to be debugged using the computer.

The invention provides a computer system for remotely debugging a computer application in a client-server arrangement, including a server linked to a client via a data network, the application executing in a memory of the server, and a debugger resident in the memory. The server is adapted for receiving a cookie from the client over the data network, and responsively to the cookie, downloading a page generated by the application to the client, actuating the debugger, and connecting the debugger to the client so as to enable the page to be debugged at the client.

### BRIEF DESCRIPTION OF THE DRAWINGS

For a better understanding of the present invention, reference is made to the detailed description of the invention, by way of example, which is to be read in conjunction with the following drawings, wherein like elements are given like reference numerals, and wherein:

FIG. 1 is a block diagram of a client-server system suitable for dynamic web page development, which is constructed and operative in accordance with a disclosed embodiment of the invention;

FIG. 2 is a flow chart illustrating a method of debugging a current page of a Web application in accordance with a disclosed embodiment of the invention;

FIG. 3 is a flow chart illustrating a method of debugging a subsequent page of a Web application in accordance with a disclosed embodiment of the invention;

FIG. 4 is a flow chart illustrating a method of debugging all forms of a Web application in accordance with a disclosed embodiment of the invention;

FIG. 5 is a flow chart illustrating a method of debugging all pages of a Web application in accordance with a disclosed embodiment of the invention; and

FIG. 6 is a block diagram of a client-server system suitable for dynamic web page development, which is constructed and operative in accordance with an alternate embodiment of the invention.

### DETAILED DESCRIPTION OF THE INVENTION

In the following description, numerous specific details are set forth in order to provide a thorough understanding of the present invention. It will be apparent to one skilled in the art, however, that the present invention may be practiced without these specific details. In other instances well-known circuits, control logic, and the details of computer program instructions for conventional algorithms and processes have not been shown in detail in order not to unnecessarily obscure the present invention.

Software programming code, which embodies aspects of the present invention, is typically maintained in permanent storage, such as a computer readable medium. In a client/server environment, such software programming code may be stored on a client or a server. The software programming code may be embodied on any of a variety of known media for use with a data processing system. This includes, but is not limited to, magnetic and optical storage devices such as disk drives, magnetic tape, compact discs (CD's), digital video discs (DVD's), and computer instruction signals embodied in a transmission medium with or without a carrier wave upon which the signals are modulated. For example, the transmission medium may include a communications network, such as the Internet.

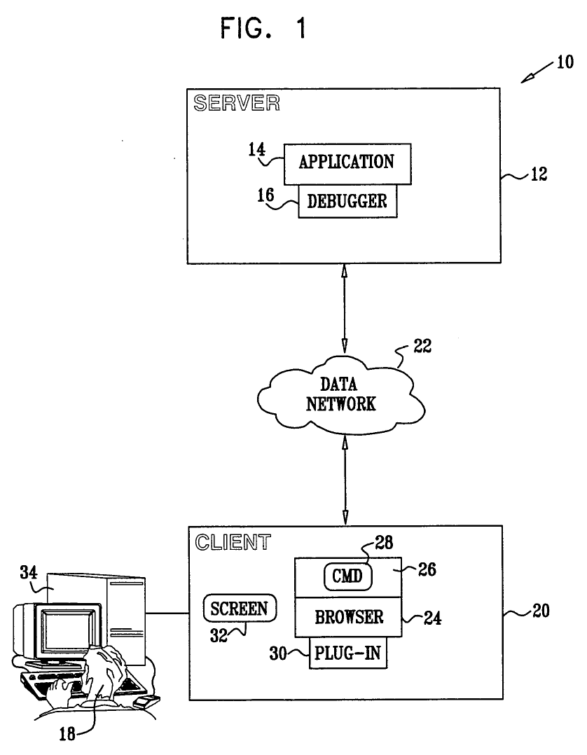

Turning now to the drawings, reference is initially made to FIG. 1, which is a block diagram of a client-server system 10 suitable for dynamic web page development, which is constructed and operative in accordance with a disclosed embodiment of the invention. A server 12 executes an application 14 under development. The application 14 may be realized as a PHP:hypertext preprocessor (PHP) script that is executed using a Zend Engine (version 2 or higher). PHP is a widely used general-purpose scripting language that is especially suited for Web development, and can be embedded into hypertext markup language (HTML) documents. PHP (version 4 or higher) and the Zend engine are both available from Zend Technologies Ltd., P.O. Box 3619, Ramat Gan, Israel, 52136. It should be noted that while current versions of the system 10 employ PHP and the Zend engine, as they are particularly well adapted to dynamic web site development, the principles of the present invention may be applied to other computer languages and run-time environments using techniques known to the art, for example Microsoft® ASP.NET. A debugger 16, such as the Zend Debugger, which is a feature of the above-noted PHP product, also resides in the server 12. In normal run mode, the debugger 16 is disconnected from the application 14. When actively debugging, it is necessary that the application 14 be connected to the debugger 16, so that a remote user or operator 18 may undertake debugging operations, such as single-step program execution, viewing contents of program variables, or examining the state of the processor of the server 12. Enabling the operator 18 to effortlessly establish this connection is the subject of the present invention.

A remote client 20 is connected to the server 12 via a data network 22, which can be the Internet. The client 20 is typically a general purpose computer or workstation. The client 20 is provided with a browser 24 for establishing communication with the server 12 via the data network 22, typically using the well-known HTTP protocol.

The browser 24 includes a toolbar 26 having a specialized command button 28, which is actuated conventionally by the operator 18 using a mouse click or an accelerator key. An accessory program, typically implemented as a browser plug-in 30, executes responsively to actuation of the command button 28. Although only one command button is shown in FIG. 1, it may be desirable to provide a plurality of command buttons, which can be selectively engaged to invoke different modes of debugging operation, as explained in further detail hereinbelow.

The browser 24 can be any commercially available browser, such as the Netscape™ Browser, available from Netscape Communications Corporation, P.O. Box 7050 Mountain View, Calif. 94039-7050, Internet Explorer™, available from Microsoft Corporation, One Microsoft Way, Redmond, Wash. 98052-6399, or the Mozilla™ Browser, available from The Mozilla Foundation c/o OSAF, 543 Howard St. 5th Floor, San Francisco, Calif. 94105. The plug-in 30 may be implemented according to the respective conventions of the browser selected as the browser 24, as is known in the art, and typically is represented on the browser screen as a toolbar. An implementation of the plug-in 30 suitable for the Mozilla browser is included herein in the above-noted computer program listing appendices.

When the debugger 16 becomes active, a debugging screen 32 is presented to the operator 18 on a monitor 34. By viewing and modifying the screen 32, the operator 18 is enabled to evaluate the state of the application 14 and to control its execution using the debugger 16.

A cookie is a piece of information shared between the client and the server. A cookie originates as a message sent by a Web server to a Web browser visiting the server's site, and is subsequently stored in a text file on the hard drive of the user or client. The cookie is sent back to the server each time the browser requests a page from the server. In one common way of using cookies, it is possible to reconstruct the URL paths that individual users traverse, and from this to obtain the most frequently traversed paths through the Web site.

Cookies are employed according to the present invention in a somewhat different way in order for the client 20 to activate and control the debugger 16. When the command button 28 is engaged, the plug-in 30 originates a cookie at the client 20 that is then stored in its memory, as if it had been originated by the server. This cookie contains information identifying the client 20, typically an IP address, an identifier of the process to be debugged, and the port on which the client is listening. The cookie also contains instructions regarding an action to be taken by the server 12. Typically, the action to be taken is activation or deactivation of the debugger 16. Certain alternate actions are disclosed in further detail hereinbelow. The cookie may contain additional control information, such as enablement of single-step operation of the debugger 16, and the scope of the debugging session, i.e., one-time or persistent operation of the debugger 16. Additionally or alternatively, the control information in the cookie may include a specification of a particular frame of the current web page that is to be debugged. In a further alternative, the control information may specify whether the current web page or a subsequently downloaded web page is to be debugged. When the cookie is transmitted to the server 12, the plug-in 30 causes the browser 24 to concurrently generate a HTTP request for a forced refresh of the current page.

Responsively to detecting the cookie, the server 12 identifies the application 14, and causes the debugger 16 to connect to it. The requested Web page is thereupon returned to the client 20, using the address and port found in the cookie. The server 12 may also instruct the client 20 to delete the cookie. The returned Web page is displayed on the screen 32 in a format suitable for debugging the program code driving the page. It should be noted that all the information conventionally required to be supplied by the operator 18 manually is automatically incorporated in the cookie, so that the debugger 16 is controlled without manual intervention other than engagement of the command button 28.

Once the connection between the application 14 and the debugger 16 is established, the client 20 controls the server 12 over a direct TCP/IP link.

First Mode of Operation.

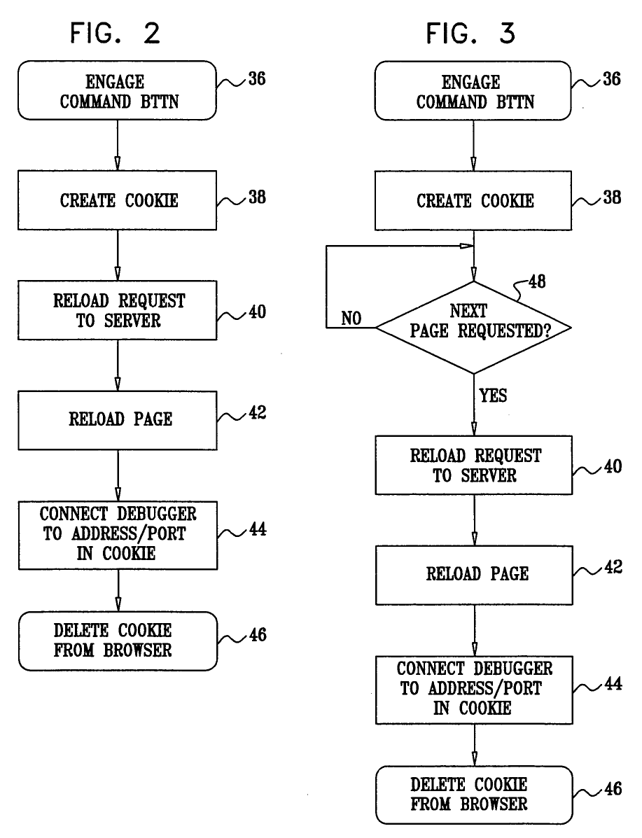

Reference is now made to FIG. 2, which is a flow chart illustrating a method of debugging a current page of a Web application in accordance with a disclosed embodiment of the invention. For purposes of this and subsequent modes of operation described herein, it is assumed that the arrangement shown in FIG. 1 is in effect. Furthermore, details of steps previously described are generally not repeated in the interest of brevity.

At initial step 36 the operator engages a command button on the toolbar of the Web browser indicating a desire to debug the current Web application under development that is executing on a remote Web server.

Next, at step 38 the plug-in associated with the toolbar generates one or more cookies, and sets them in the Web browser. It will be apparent to those skilled in the art that HTTP is a stateless protocol. The application in the Web server that generated the current page has completed its execution, and at this point, the Web browser is disconnected from the Web server. Thus, in order to debug the current page, it must be refreshed in the Web browser. At step 40, a HTTP request to reload the current page is transmitted to the Web server. The cookie may optionally specify that a frame of the current page is to be debugged.

Next, at step 42 the application in the Web server regenerates the current page. The Web server reloads the current Web page into the Web browser, concurrently accessing the cookies.

Next, at step 44, the Web server analyzes the cookie, and determines that a debug session has been requested. The debugging program is actuated, and the server connects back to the address and port designated in the cookie. A debug session begins.

Next, at final step 46, the Web server instructs the browser to delete the cookie from its local storage.

Second Mode of Operation.

Reference is now made to FIG. 3, which is a flow chart illustrating a method of debugging a subsequent page of a Web application in accordance with a disclosed embodiment of the invention.

Following performance of initial step 36 and step 38, control passes to delay step 48, where a request by a user for download of a subsequent Web page into the Web browser is awaited. After receipt of the desired Web page, step 40, step 42, step 44, and final step 46 are performed as in the First Mode of Operation.

Third Mode of Operation.

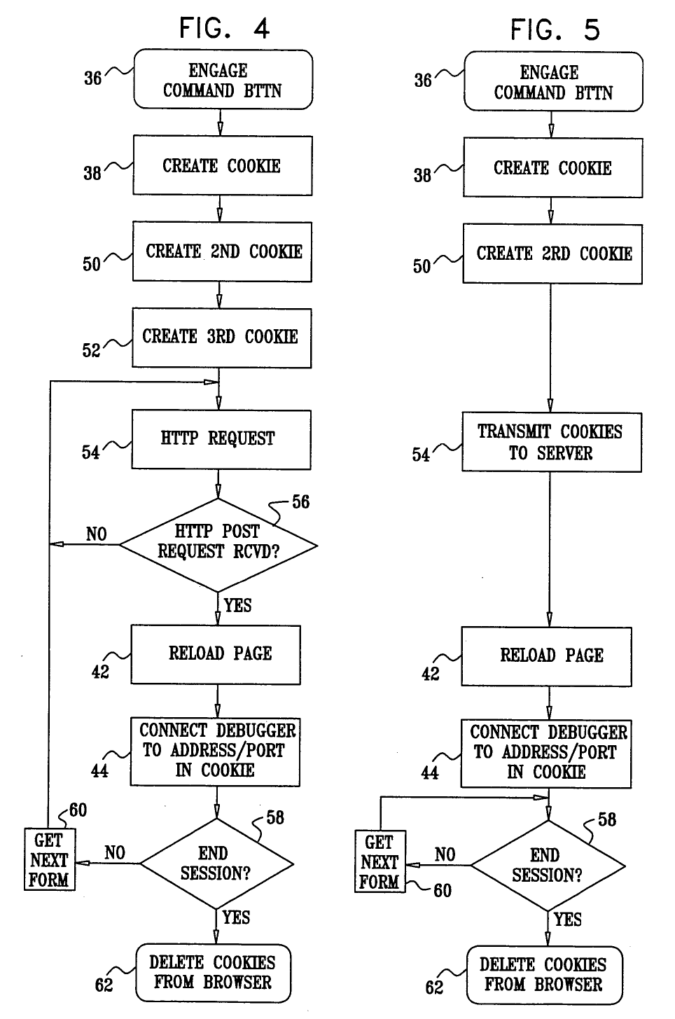

Reference is now made to FIG. 4, which is a flow chart illustrating a method of debugging all forms of a Web application in accordance with a disclosed embodiment of the invention.

After performing initial step 36 and step 38, control passes to step 50, where the plug-in associated with the toolbar generates a second cookie. This cookie contains information that inhibits the Web server from causing the cookie that was created at step 38 from the Web browser to be deleted.

Next, at step 52, the plug-in associated with the toolbar generates a third cookie. The third cookie instructs the Web server not to initiate a debug session until a HTTP POST request is received. The HTTP POST method is typically used for handling forms.

Next, at step 54, HTTP requests are routinely transmitted from the client to the Web server. The Web server becomes aware of the cookies that were created in step 38, step 50, and step 52 in the course of processing such HTTP requests, but, in consequence of the third cookie generated at step 52, takes no action with regard to establishing a debug session until a HTTP POST request is received.

Control now proceeds to decision step 56, where a determination is made whether a HTTP request received in step 54 is a HTTP POST request. If the determination at decision step 56 is negative, then control returns to step 54.

If the determination at decision step 56 is affirmative then control proceeds to step 42. Upon receipt of a HTTP POST request, step 42 and step 44 are performed as in the First Mode of Operation disclosed above.

Next, at decision step 58 a determination is made whether all forms of the Web Application have been debugged. This determination is normally made by the user. If the determination at decision step 58 is negative, then control proceeds to step 60. Here the next form is requested for debugging. Control then returns to step 54. The cookies that were created in step 38, step 50, and step 52 remain operative, and will be recognized by the Web server in subsequent operations.

If the determination at decision step 58 is affirmative, then control proceeds to final step 62. Once the user has finished debugging forms, he interacts with the toolbar, which thereupon deletes the cookies that were created in step 38, step 50, and step 52. This effectively means that the Web server no longer sees these cookies and will not initiate debug sessions in subsequent page downloads.

Fourth Mode of Operation.

Reference is now made to FIG. 5, which is a flow chart illustrating a method of debugging all pages of a Web application in accordance with a disclosed embodiment of the invention. This mode of operation is similar to the Third Mode of Operation described above and can be best understood with continued reference to FIG. 4. In this mode of operation, the Web server need not be instructed to distinguish HTTP POST requests from other HTTP requests, as all pages are to be processed, not merely forms. It is possible to specify frames of a particular page to debug by modifying the cookie. Consequently, step 52 and decision step 56 are omitted. In FIG. 5, step 54 and final step 62 are modified to only process the cookies that were created in step 38 and step 50. Step 60 is replaced by step 64, at which the next page (or frame) is obtained for debugging, instead of the next form as in the Third Mode of Operation.

Alternate Embodiment.

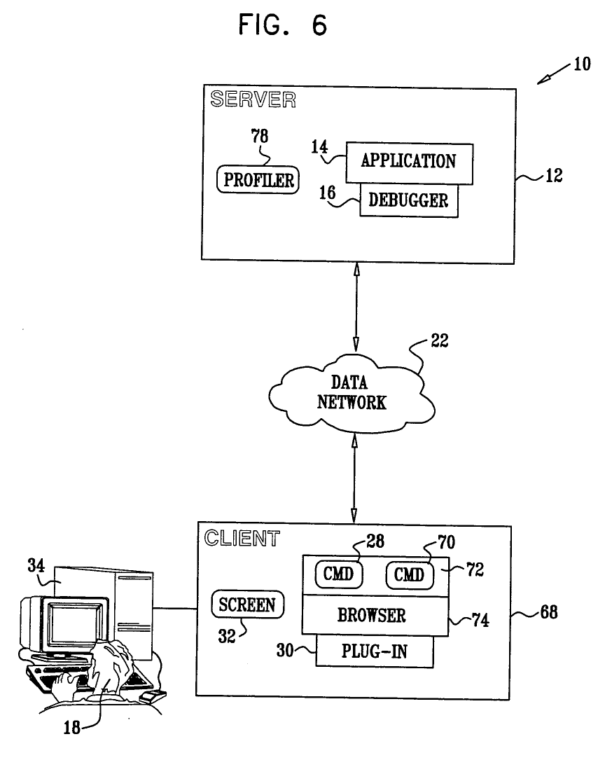

Reference is now made to FIG. 6, which is a block diagram of a client-server system 66 suitable for dynamic web page development, which is constructed and operative in accordance with an alternate embodiment of the invention, and which is generally similar to the system 10 (FIG. 1). In this embodiment, the capability of one-click debugging is enhanced in a client 68 by an additional command button 70 in a toolbar 72 of a browser 74. A Web server 76 is similar to the server 12 (FIG. 1), except now it is provided with a profiling application 78.

Following actuation of the command button 70, the plug-in 30 originates a control cookie at the client 68. This cookie is stored on the client 68, and transmitted to the Web server, which then causes the profiling application 78 to transmit a performance profile of the application 14 to the client 20.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art, which would occur to persons skilled in the art upon reading the foregoing description.

### APPENDIX 1

### Installation Instructions for Computer Program Listing Appendix

Note on File Nomenclature.

CONTENTS.HEX is a hex representative of the file CONTENTS.

DIFFS.HEX is a hex representative of the file DIFFS.

ZENDSTUDIOTOOLBARFRAMESJS.HEX is a hex representative of the file ZENDSTUDIOTOOLBARFRAMES.JS.

ZENDSTUDIOTOOLBARFRAMESXUL.HEX is a hex representative of the file ZENDSTUDIOTOOLBARFRAMES.XUL.

ZENDSTUDIOTOOLBAROVERLAYJS.HEX is a hex representative of the file ZENDSTUDIOTOOLBAROVERLAY.JS.

ZENDSTUDIOTOOLBAROVERLAYXUL.HEX is a hex representative of the file ZENDSTUDIOTOOLBAROVERLAY.XUL.

ZENDSTUDIOTOOLBARSETTINGSJS.HEX is a hex representative of the file ZENDSTUDIOTOOLBARSETTINGS.JS.

ZENDSTUDIOTOOLBARSETTINGSXUL.HEX is a hex representative of the file ZENDSTUDIOTOOLBARSETTINGS.XUL.

ZENDSTUDIOTOOLBARABOUTXUL.HEX is a hex representative of the file ZENDSTUDIOTOOLBARABOUT.XUL.

ZENDTOOLBARJPGZIP.HEX is one zipped and then hexed file containing the following files: debug.jpg, extra_stuff.jpg, php_net.jpg, profile.jpg, Studio.jpg and zend_com.jpg.

Server Hardware:

Provide an IBM compatible personal computer with a minimum of 256 MB RAM and an Intel Pentium IV central processing unit, one IDE hard disk with a minimum of 1 Gigabyte of free disk space.

Server Software (Installation):

Install Microsoft Windows 2000 operating system with TCP/IP enabled available from Microsoft Corporation.

Install the server option of the Zend Studio version 3.0 available from Zend Technologies Ltd.

Install the Mozilla™ Browser version 1.4.x available from The Mozilla Foundation.

Copy the file ZENDTOOLBARXPI.HEX in the root folder stored in the appended CD-ROM into a temporary directory.

Unhex the computer listing ZENDTOOLBARXPI.HEX using HEX IT V1.8 or greater by John Augustine, 3129 Earl St., Laureldale, Pa. 19605, USA creating the file ZENDTOOLBAR.XPI.

Configuring the Mozilla Browser.

Launch the Mozilla browser.

Click the File menu.

Select the Open File menu item.

Navigate to the directory where the file ZENDTOOLBAR.XPI is located, select it, and click Open.

A popup dialog will appear. Click Install

Quit the Mozilla browser, and start it again.

Client Hardware:

Provide an IBM compatible personal computer with a minimum of 256 MB RAM and an Intel Pentium IV central processing unit, one IDE hard disk with a minimum of 1 Gigabyte of free disk space.

Client Software (Installation):

Install Microsoft Windows 2000 operating system available from Microsoft Corporation.

Install the client option of the Zend Studio version 3.0 available from Zend Technologies Ltd.

Install the Mozilla™ Browser version 1.4.x available from The Mozilla Foundation.

Copy the file ZENDTOOLBARXPI.HEX in the root folder stored in the appended CD-ROM into a temporary directory.

Unhex the computer listing ZENDTOOLBARXPI.HEX using HEX IT V1.8 or greater by John Augustine, 3129 Earl St., Laureldale, Pa. 19605, USA creating the file ZENDTOOLBAR.XPI.

Configuring the Mozilla Browser:

Launch the Mozilla browser

Click the File menu

Select the Open File menu item

Navigate to the directory where the file ZENDTOOLBAR.XPI is located, select it, and click Open.

A popup dialog will appear. Click Install

Quit the Mozilla browser, and start it again

1. A method for remotely debugging a web application that is executing on a server from a client that is linked to said server in a data network, comprising the steps of:
at said client browsing a page that is generated by said application;
generating a cookie at said client responsively to a request by a user of said client to debug said application; and
transmitting said cookie to said server via said data network, wherein said server is adapted to actuate a debugger responsively to said cookie, and to connect said debugger to said client so as to enable said page to be debugged at said client.

2. The method according to claim 1, wherein said step of generating said cookie is performed by engaging a command button on a browser of said client to cause said cookie to be automatically generated.

3. The method according to claim 1, wherein said step of generating said cookie includes generating a HTTP request in said client for a forced refresh of said page and transmitting said HTTP request to said server.

4. The method according to claim 3, wherein said cookie specifies a frame of said page for debugging.

5. The method according to claim 1, further comprising the steps of memorizing said cookie in said client, and following performance of transmitting said cookie to said server, causing said client to delete said memorized cookie.

6. The method according to claim 1, further comprising the steps of memorizing said cookie in said client, and following performance of transmitting said cookie to said server, causing said client to preserve said memorized cookie.

7. The method according to claim 1, further comprising the steps of:
incorporating an instruction in said cookie that causes said server to actuate said debugger only after receipt of a HTTP POST request from said client; and
thereafter sending said HTTP POST request from said client to said server.

8. The method according to claim 1, wherein said application is written in a scripting language.

9. A method for remotely debugging a web application that is executing on a server from a client that is linked to said server in a data network, comprising the steps of:
receiving a cookie at said server from said client over said data network;
responsively to said cookie, downloading a page generated by said application on said server to said client and actuating a debugger; and
connecting said debugger to said client so as to enable said page to be debugged at said client.

10. The method according to claim 9, further comprising the step of viewing a current page of said application on a browser at said client, wherein said page comprises a subsequent page of said application.

11. The method according to claim 9, wherein said cookie is generated by engaging a command button on a browser of said client to cause said cookie to be automatically generated.

12. The method according to claim 9, further comprising the step of receiving a HTTP request in said server from said client for a forced refresh of said page.

13. The method according to claim 9, further comprising the step of transmitting an instruction from said server to said client that causes said client to delete said cookie from a memory thereof.

14. The method according to claim 9, further comprising the step of causing said server to withhold sending a delete-cookie instruction to said client.

15. The method according to claim 9, wherein said cookie includes an instruction in said cookie that causes said server to actuate said debugger only after receipt of a HTTP POST request from said client.

16. The method according to claim 9, wherein said application is written in a scripting language.

17. A computer software product, comprising a computer-readable medium in which computer program instructions are stored, which instructions, when read by a computer, cause the computer to perform a method for debugging a computer application that is executing on a remote server that is linked to said computer in a data network, comprising the steps of:
displaying a page that is generated by said application on a browser in said computer;
generating a cookie and
transmitting said cookie to said server via said data network, wherein said server is adapted to actuate a debugger responsively to said cookie, and to connect said debugger to said computer so as to enable said page to be debugged.

18. The computer software product according to claim 17, wherein said step of generating said cookie is performed automatically following engagement of a command button on said browser.

19. The computer software product according to claim 17, wherein said step of generating said cookie includes generating a HTTP request for a forced refresh of said page and transmitting said HTTP request to said server.

20. The computer software product according to claim 19, wherein said cookie specifies a frame of said page for debugging.

21. The computer software product according to claim 17, wherein said computer is further instructed to perform the steps of memorizing said cookie, and following performance of transmitting said cookie to said server, deleting said memorized cookie.

22. The computer software product according to claim 17, further comprising the steps of:
incorporating an instruction in said cookie that causes said server to actuate said debugger only after receipt of a HTTP POST request from said computer; and
thereafter sending said HTTP POST request to said server.

23. A computer software product, comprising a computer-readable medium in which computer program instructions are stored, which instructions, when read by a server, cause said server to perform a method for remotely debugging a computer application that is executing on said server from a client that is linked to said server in a data network, comprising the steps of:
receiving a cookie from said client over said data network;
responsively to said cookie, downloading a page generated by said application to said client and actuating a debugger; and
connecting said debugger to said client so as to enable said page to be debugged at said client.

24. The computer software product according to claim 23, wherein said server is further instructed to perform the step of receiving a HTTP request from said client for a forced refresh of said page.

25. The computer software product according to claim 23, wherein said server is further instructed to perform the step of transmitting an instruction to said client that causes said client to delete said cookie from a memory thereof.

26. The computer software product according to claim 23, wherein said server is further instructed to perform the step of transmitting an instruction to said client that prevents said client from deleting said cookie from a memory thereof.

27. The computer software product according to claim 23, wherein said cookie includes an instruction in said cookie that causes said server to actuate said debugger only after receipt of a HTTP POST request from said client.

28. The computer software product according to claim 23, wherein said application is written in a scripting language.

29. A computer system for remotely debugging a computer application that is executing on a server that is linked to said system in a data network, comprising:
a computer having a memory;
a browser executing in said computer; and
a toolbar in said browser having a command button, said toolbar further comprising program instructions for automatically generating a cookie responsively to engagement of said command button, for storing said cookie in said memory, and for causing said cookie to be transmitted from said computer to said server via said data network, wherein said server is adapted to actuate a debugger responsively to said cookie, and to connect said debugger to said computer so as to enable said application to be debugged using said computer.

30. The computer system according to claim 29, wherein said program instructions of said toolbar cause said computer to generate a HTTP request for a forced refresh of a page being displayed in said browser and to transmit said HTTP request to said server.

31. The computer system according to claim 29, wherein said program instructions cause a directive to be incorporated in said cookie that causes said server to actuate said debugger only after receipt of a HTTP POST request, and cause said computer to send said HTTP POST request to said server.

32. The computer system according to claim 29, wherein said application is written in a scripting language.

33. A computer system for remotely debugging a computer application in a client-server arrangement linked in a data network, comprising:
a server having a memory and linked to a client via said data network, said application executing in said memory;
a debugger resident in said memory; and
said server being adapted for receiving a cookie from said client over said data network, and responsively to said cookie, downloading a page generated by said application to said client, actuating said debugger, and connecting said debugger to said client so as to enable said page to be debugged at said client.

34. The computer system according to claim 33, wherein said cookie is generated by engaging a command button on a browser of said client to cause said cookie to be automatically generated.

35. The computer system according to claim 33, wherein said server is further adapted for receiving a HTTP request in said server from said client for a forced refresh of said page.

36. The computer system according to claim 33, further comprising the step of transmitting an instruction from said server to said client that causes said client to delete said cookie from a client memory thereof.

37. The computer system according to claim 33, wherein said server is further adapted for transmitting an instruction from said server to said client that prevents said client from deleting said cookie from a client memory thereof.

38. The computer system according to claim 33, wherein said cookie includes an instruction in said cookie that causes said server to actuate said debugger only after receipt of a HTTP POST request from said client.

39. The computer system according to claim 33, wherein said application is written in a scripting language.
